(19) United States
(12) Patent Application Publication
(10) Pub. No.: US 2018/0168936 A1
(43) Pub. Date: Jun. 21, 2018

(54) BACTERIA CONTAINMENT APPARATUS FOR A BABY BOTTLE

(71) Applicants: Christopher Stanislawczyk, Hyattsville, MD (US); Corinne Anne Sebesta Sisti, Penn Valley, PA (US)

(72) Inventors: Christopher Stanislawczyk, Hyattsville, MD (US); Corinne Anne Sebesta Sisti, Penn Valley, PA (US)

(21) Appl. No.: 15/383,583

(22) Filed: Dec. 19, 2016

(51) Int. Cl. A61J 9/00; A61J 11/04

(52) U.S. Cl. CPC A61J 9/00; A61J 11/045

(57) ABSTRACT

An apparatus and method for containing bacteria in an infant bottle that prevents unswallowed formula from returning to the unused formula in the bottle. The apparatus includes a plurality of one-way valves positioned across a containment chamber and all located between the bottle opening and the nipple. The plurality of one-way valves allows uncontaminated formula to flow out of the bottle portion during suction on the nipple. However, once suction is removed and if formula that has come into contact with the infant makes its way back into the nipple, the plurality of one-way valves close blocking the return path to the bottle portion. Should any contaminated formula makes its way through one of the one-way valves, the contaminated fluid is then trapped within the containment chamber and the remaining one-way valve is closed when suction is removed. Gaskets in and beneath the containment chamber form further sealing means.

### BACKGROUND OF THE INVENTION

The present invention relates generally to drinking bottles and, more particularly, to an apparatus for containing bacteria in an infant bottle that prevents unswallowed, or otherwise contaminated, formula from returning via the nipple to the unused formula in the bottle.

After baby formula is prepared, most baby formula manufacturers recommend discarding any unused formula 24 hours after preparation. Furthermore, if the infant fails to finish a bottle of formula, it is recommended that the unconsumed formula remaining in the bottle be discarded 1 hour after the start of feeding. The 1 hour rule is due to bacteria growth in the unconsumed formula caused by an infant's saliva mixing with the formula in the bottle. However, conventional infant bottles have no means for preventing the unused contaminated formula from making its way back to the uncontaminated formula in the bottle portion.

The following patent publications are related to controlling the flow of air and/or bottle content during use: U.S. Pat. Nos. 4,010,861 (Welten); 5,431,290 (Vinciguerra); 5,664,705 (Stolper); 5,791,503 (Lyons); 6,089,260 (Jaworski, et al.); 7,832,576 (Cohn); 8,875,913 (Diaz); as well U.S. Patent Publication Nos. 2011/0297634 (Diaz); 2013/0026196 (Essebaggers, et al.); 2013/0098861 (Lair, et al.); 2015/0069005(Diaz); 2015/0307231 (Diaz); and the following: GB 1018822 (Moontasir); GB 2169210 (Haberman); CN 202113348 (Li); and CN 204477401 (Chen).

However, many of the devices of these references suffer from the need for specially-designed or customized valves or flow structures, fail to provide air tight seals that could result in leakage, may not be usable with various types of nipple configurations, and may fail to work when the bottle is inverted.

So while the devices of the aforementioned patents are suitable for their intended purposes, they nevertheless leave something to be desired from the standpoint of preventing contaminated formula from finding its way back to the unused formula in the bottle. Thus, a need exists for an apparatus and method of use which overcomes the drawbacks of the prior art and extends the length of time that any unconsumed infant formula in a bottle of partially-consumed formula may be used. The subject invention addresses that need.

All references cited herein are incorporated herein by reference in their entireties.

### BRIEF SUMMARY OF THE INVENTION

An apparatus, adapted for use with an infant's bottle having bottle portion, a releasable screw ring and a nipple, for preventing contaminated formula from mixing with uncontaminated formula in the bottle portion is disclosed. The apparatus comprises: a plurality of one-way valves (e.g., umbrella valves, duckbill valves, floating ball valves, spring-loaded valves, etc.) that permit the passage of formula in one direction from the bottle portion to the nipple; a containment chamber for providing a space between the plurality of one-way valves to form an assembly. The assembly is positioned between an opening in the bottle portion and the nipple and wherein the assembly is releasably secured between the opening and the nipple when the releasable screw ring is secured thereover. The assembly prevents any formula that passed through a nipple opening and into contact with the infant and then is returned through the nipple opening from returning to the bottle portion.

A method for preventing contaminated formula from mixing with uncontaminated formula in a bottle portion of an infant's bottle having a releasable screw ring and a nipple is disclosed. The method comprises: (a) positioning a plurality of one-way valves (e.g., umbrella valves, duckbill valves, floating ball valves, spring-loaded valves, etc.), separated across a chamber, at the opening of the bottle portion to form an assembly; (b) releasably securing the nipple on the assembly at the opening of the bottle portion using the releasable screw ring; (c) applying suction to the nipple to draw uncontaminated formula from the bottle portion through the opening and through the plurality of valves that are opened by said suction and exiting an opening in the nipple, said drawn formula coming into contact with an infant to form a contaminated formula; (d) permitting the contaminated formula to re-enter the opening in the nipple; and (e) preventing, by a closure of the one of said plurality of one-way valves, the contaminated formula from passing therethrough.

An infant's bottle that prevents contaminated formula from mixing with uncontaminated formula in the bottle portion is disclosed. The infant's bottle comprises: a bottle portion having a threaded outer neck with an opening and a screw ring that releasably engages therewith to releasably secure a nipple to the opening; a plurality of one-way valves (e.g., umbrella valves, duckbill valves, floating ball valves, spring-loaded valves, etc.) that permit the passage of formula in one direction from the bottle portion to the nipple; a containment chamber for providing a space between the plurality of one-way valves to form an assembly; the assembly being positioned between the opening in the bottle portion and the nipple and wherein the assembly is releasably secured between the opening and the nipple when the releasable screw ring is secured thereover, and wherein the assembly prevents any formula that passed through a nipple opening and into contact with the infant and then is returned through the nipple opening from returning to the bottle portion.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an exploded view of the present invention being used with a conventional baby bottle;

FIG. 1A is an assembled baby bottle using the present invention;

FIG. 2A is a cross-sectional view of the baby bottle using the present invention taken along line 2A-2A showing the one-way valves in a closed position and wherein contaminated formula that contacted the infant and was drawn back into the nipple is confined to the nipple or to the bacteria containment chamber;

FIG. 2B is a cross-sectional view of the baby bottle using the present invention similar to FIG. 2A but with the one-way valves in an open position showing the passage of formula through the containment chamber and the upper valve and to the nipple for consumption by the infant;

FIG. 3A is an enlarged cross-sectional view of an exemplary one-way valve of the present invention shown in its closed position;

FIG. 3B is an enlarged cross-sectional view of an exemplary one-way valve of the present invention shown in its open position; and

FIG. 3C is an enlarged cross-sectional view of an exemplary one-way valve of the present invention shown in its cleaning position.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

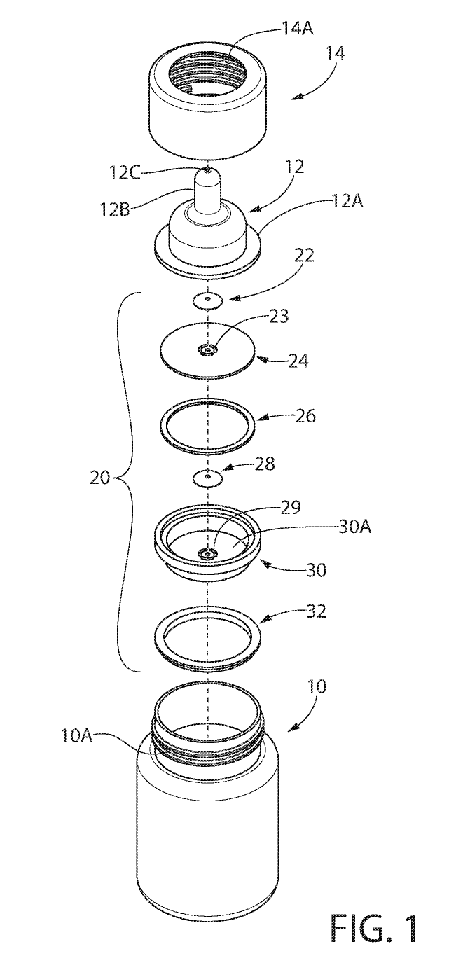

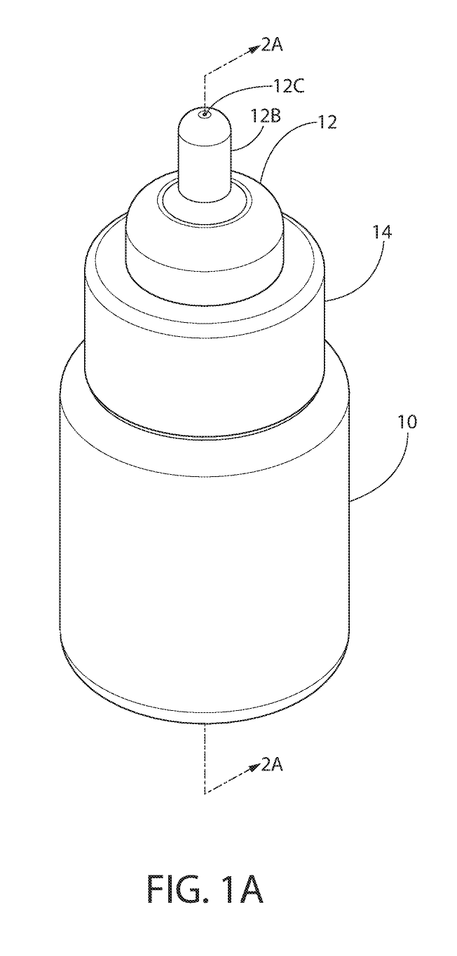

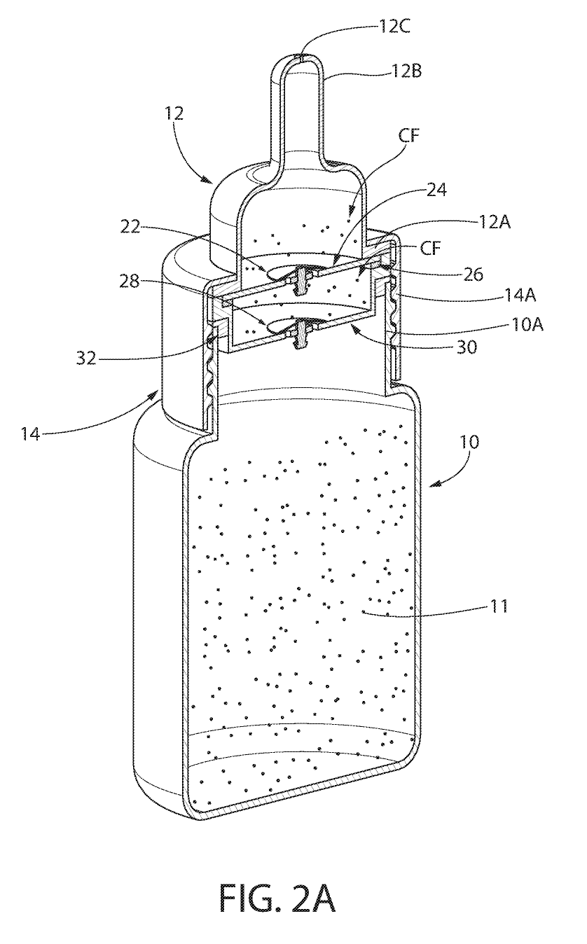

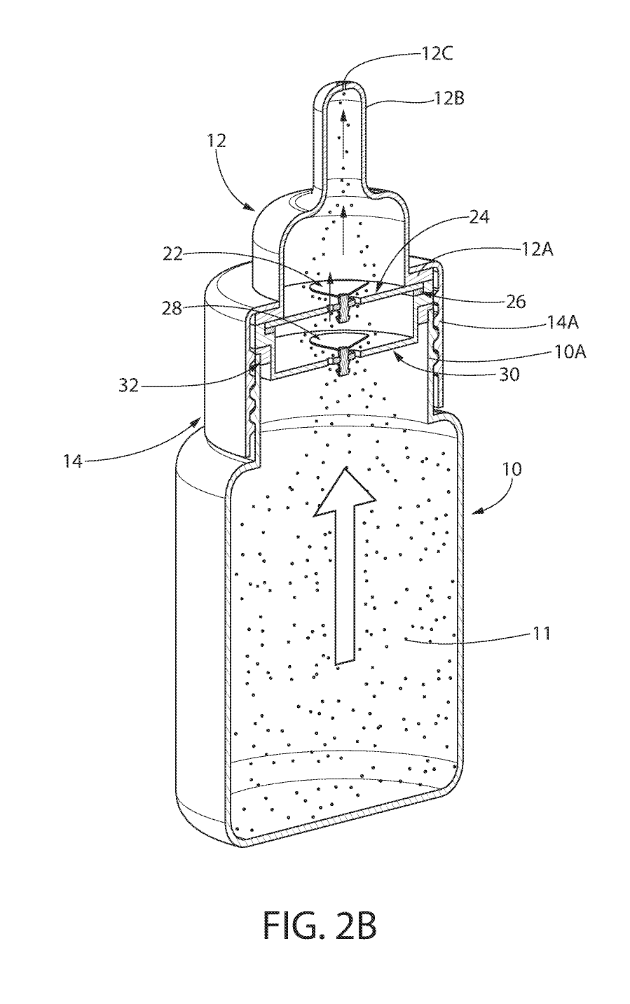

FIG. 1 depicts and exploded view of the bacteria containment apparatus (BCA) 20 used with a conventional baby bottle 10. In particular, the BCA 20 comprises a first one-way valve 22 engaged with a valve plate 24. The valve 22/plate 24 are received on a shoulder within a containment basket 30 via a plate gasket 26. A bottom surface 30A of the containment basket 30 acts as another valve plate for a second one-way valve 28 that is engaged therein. Finally, the containment basket 30 is received inside the mouth of the conventional baby bottle 10 with a containment gasket 32 interposed therebetween, which also aids in centering the containment basket 30 within the bottle 10 mouth. To secure the BCA 20 to the bottle 10, a screw ring 14 having threads 14A is passed over the BCA 20 and engaged with the threads 10A on the bottle 10. FIG. 2A depicts how the screw ring 14 releasably secures the BCA 20 between a nipple flange 12A of the nipple 12 and the opening to the bottle 10. As shown in FIG. 2A, the valve plate 24 and the containment basket 30 form a “containment chamber” having a pair of one-way valves 22/28 separated across the chamber; as such, these one-way valves 22 and 28 are positioned opposite each other, on respective ends of the chamber. The plate gasket 26 and containment gasket 32, in conjunction with the containment basket 30, the valve plate 24 and the nipple 12 result in an air tight seal between the bottle 10 and the containment basket 30, between the containment basket 30 and the valve plate 24 and between the valve plate 24 and the nipple 12.

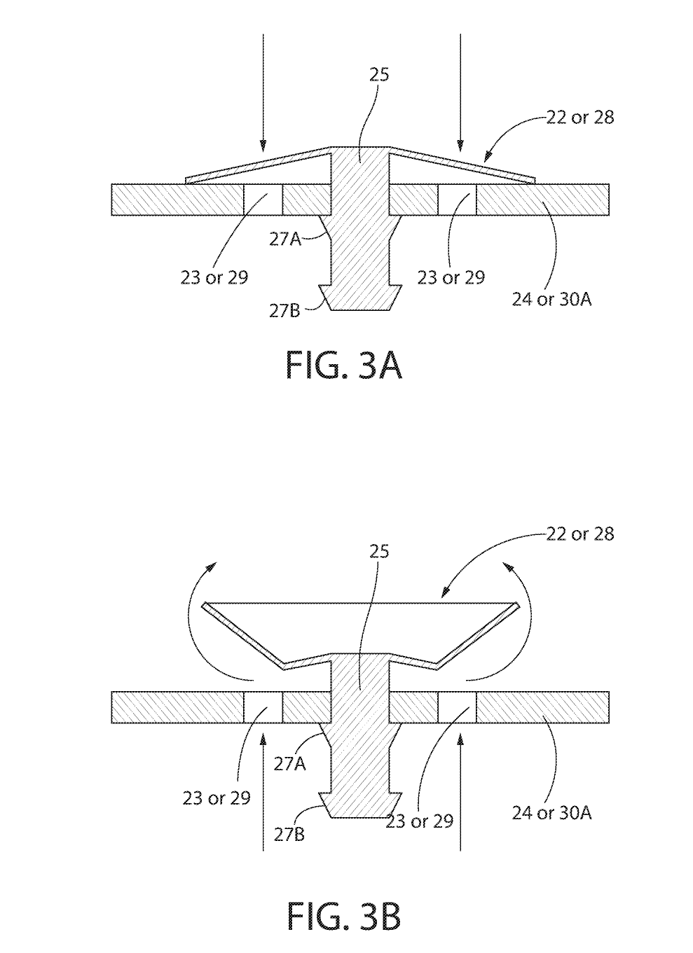

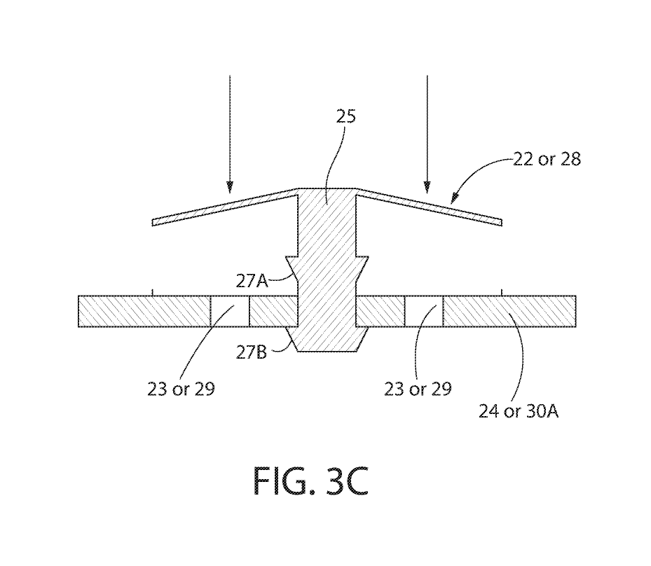

The one-way valves 22 and 28 may comprise passive (e.g., umbrella valves, duckbill valves, etc.) or dynamic valves (e.g., floating ball valves, spring-loaded valves, etc.). An exemplary valve is an umbrella valve (e.g., umbrella valves UM 145.003 or 160.001 manufactured by MiniValve, Inc. of Cleveland, Ohio) and which comprises a food-safe material. As shown in FIG. 3A, the umbrella valve 22 or 28 comprises an elastomeric material having a diaphragm-shaped top and a central shank 25 and a stop 27. The shank 25 and first stop 27A and second stop 27B are pushed through a central aperture in the valve plate 24 or the containment basket bottom surface 30A; the stop 27A locks the shank 25 against the bottom surface of the valve plate 24 or the containment bottom surface 30A. In a closed position, when no suction is applied above the diaphragm-shaped top, normal air pressure (see arrows in FIG. 3A) presses down in the diaphragm-shaped top, thereby covering apertures 23 in the valve plate 24, or apertures 29 in the containment basket bottom surface 30A. Conversely, when suction is applied above the diaphragm-shaped top (e.g., when the infant sucks on the nipple 12), the greater air pressure underneath the valve plate 24 and the containment basket bottom surface 30A drives the diaphragm-shaped top upward (FIG. 2B and 3B), thereby allowing uncontaminated formula 11 (FIGS. 2A-2B) to pass upward through the apertures 23 or 29 in the first and second one-way valves 22/28. The pressure necessary to switch the one-way valves 22/28 from a closed state to an open state is referred to as the “cracking pressure.” In this application, the cracking pressure is high enough to prevent the valves 22/28 from opening under the weight of the formula 11 (e.g., when the bottle 10 is inverted) but yet low enough to open under typical suction by the infant. Furthermore, when it is necessary to clean the BCA 20, each second stop 27B of the one-way valves 22/28 is pushed upward to force the first stop 27A up through the valve plate 24 and up through the bottom surface 30A of the containment basket 30 (see FIG. 3C). This permits the shank 25 and the first stop 27A to be thoroughly cleaned during washing. Once washing is complete and the BCA 20 components dried, the second stops 27B of each one-way valve 22/28 are pulled downward so that the first stops 27A are underneath the valve plate 24 and underneath the bottom surface 30A of the containment basket 30 as shown in FIG. 3A and the one-way valves 22/28 are ready for use.

Operation of the BCA 20 when installed with the baby bottle 10 is as follows. As the infant sucks on the nipple 12 (FIG. 2B), the cracking pressure is exceeded and the one-way valves 22/28 open (FIG. 3B), thereby allowing uncontaminated formula 11 in the bottle 10 to move upward through the bottle 10 opening, through the second one-way valve 28, through the containment chamber, through the one-way valve 22 and then through the nipple shank 12B and out through a nipple opening 12C and into the infant's mouth (not shown). Once the infant stops sucking, the one-way valves 22/28 move into the closed position (FIG. 3A). Any formula that came into contact with the infant's mouth or lips or skin or breath that makes its way back through the nipple opening 12C and shank 12B, hereinafter referred to as “contaminated formula (CF)” is now trapped above the first one-way valve 22 (FIG. 2A); or, in the slight chance that the contaminated formula CF made its way through the first one-way valve 22 (FIG. 2A) before it closed, that contaminated formula CF is now trapped in the containment chamber above the second one-way valve 28 (FIG. 2A). Thus, the BCA 20 acts to prevent back flow of bacteria generated by contact with the infant (e.g., infant's saliva or breath, fluids on the lips or skin, etc.). As a result, the formula 11 in the bottle portion remains uncontaminated from contact with the infant. If the infant has completed his/her feeding, the screw ring 14 is disengaged from the bottle 10 and the nipple 12 and BCA 20 are removed and cleaned to discard the contaminated formula CF therefrom. The uncontaminated formula 11 remaining in the bottle 10 can then be stored per the formula manufacturer's recommendation up to a maximum of the prescribed shelf-life.

All of the components of the BCA 20 may comprise a durable material (e.g., plastic, metal, glass, etc.) that can support each of their functions and each of which can be repeatedly washed in hot water for cleaning. All of the components of the BCA 20 may comprise an antimicrobial or antibacterial coating, or can be manufactured from antimicrobial or antimicrobial materials.

It should be further understood that it is only by way of example that the six components of the BCA 20 are not unitized; for example, it is within the broadest scope of the present invention 20 that the one-way valves 22 and 28 may be pre-assembled and the gaskets 26 and 32 may be integrated (e.g., via two-shot injection molding, etc.) with the containment basket 30 such that the consumer need only stack the valve plate 24 onto the containment basket 30 and then position that assembly onto the bottle 10 opening before securing the screw ring 14 thereon. As a result, the number of distinct parts of the BCA 20 that the consumer handles does not form a limitation on the overall concept.

It is also within the broadest aspect of the present invention 20 that the BCA 20 is integrally-formed with the baby bottle 10 opening, rather than being a separate assembly from the baby bottle 10.

The BCA 20 may be used with baby bottles 10 of any type of material (e.g., plastic, metal, glass, etc.) and with any type of baby bottle 10 construction (e.g., rigid, semi-rigid, flexible, etc.). The BCA 20 can also be used with bottles 10 that are vented or non-vented, as well as with nipples 12 that are vented or non-vented.

Thus, the BCA 20 extends the shelf-life of unconsumed formula in a partially-consumed baby bottle 10 up to the formula manufacturer's suggested shelf-life of unused, open formula.

While the invention has been described in detail and with reference to specific examples thereof, it will be apparent to one skilled in the art that various changes and modifications can be made therein without departing from the spirit and scope thereof.

What is claimed is:

1. An apparatus, adapted for use with an infant's bottle having bottle portion, a releasable screw ring and a nipple, for preventing contaminated formula from mixing with uncontaminated formula in the bottle portion, said apparatus comprising:
a plurality of one-way valves that permit the passage of formula in one direction from the bottle portion to the nipple;
a containment chamber for providing a space between said plurality of one-way valves to form an assembly;
said assembly being positioned between an opening in the bottle portion and the nipple and wherein said assembly is releasably secured between the opening and the nipple when said releasable screw ring is secured thereover, said assembly preventing any formula that passed through a nipple opening and into contact with the infant and then is returned through the nipple opening from returning to the bottle portion.

2. The apparatus of claim 1 wherein said plurality of one-way valves comprises a first one-way valve positioned at a first end of said containment chamber and a second one-way valve positioned at a second end of said containment chamber.

3. The apparatus of claim 2 wherein said first end of said containment chamber comprises a valve plate having at least one aperture that is opened or closed by said first one-way valve, said valve plate being in contact with the nipple.

4. The apparatus of claim 3 wherein said second end of said containment chamber comprises at least one aperture that is opened or closed by said second one-way valve, said second end being positioned within the opening of the bottle portion.

5. The apparatus of claim 1 wherein each one of said plurality of one-way valves comprises an umbrella valve.

6. The apparatus of claim 5 wherein each of said umbrella valves comprises a shank having two stops, each of said stops located at a different position along the length of said shank.

7. A method for preventing contaminated formula from mixing with uncontaminated formula in a bottle portion of an infant's bottle having a releasable screw ring and a nipple, said method comprising:
(a) positioning a plurality of one-way valves, separated across a chamber, at the opening of the bottle portion to form an assembly;
(b) releasably securing the nipple on the assembly at the opening of the bottle portion using the releasable screw ring;
(c) applying suction to the nipple to draw uncontaminated formula from the bottle portion through the opening and through said plurality of valves that are opened by said suction and exiting an opening in the nipple, said drawn formula coming into contact with an infant to form a contaminated formula;
(d) permitting the contaminated formula to re-enter the opening in the nipple; and
(e) preventing, by a closure of said one of said plurality of one-way valves, the contaminated formula from passing therethrough.

8. The method of claim 7 further comprising:
(f) a portion of the contaminated formula getting through said one of said plurality of one-way valves; and
(g) trapping, by another one of said plurality of one-way valves, the contaminated formula within said chamber.

9. The method of claim 7 wherein said step of positioning comprises disposing a first one-way valve at a first end of said containment chamber and disposing a second one-way valve at a second end of said containment chamber.

10. The method of claim 9 wherein said step of disposing comprises positioning a valve plate, at said first end, and having at least one aperture therein for receiving said first one-way valve therein that opens and closes said aperture dependent upon the presence or absence of suction, respectively.

11. The method of claim 10 wherein said step of disposing further comprises forming at least one aperture in a second end of said chamber, said at least one aperture in said second end being opened or closed by said second one-way valve dependent upon the presence or absence of suction, respectively.

12. The method of claim 9 wherein said step of disposing first and second one-way valves comprises using an umbrella valve for said first and second one-way valves.

13. The method of claim 12 wherein said step of using an umbrella valve for said first and second one-way valves comprises forming said umbrella valve to have two stops at different positions along the length of a shank of said umbrella valve, said first stop providing an stop for use during operation of said valve and said second stop for use during cleaning of said valve.

14. An infant's bottle that prevents contaminated formula from mixing with uncontaminated formula in the bottle portion, said infant's bottle comprising:
a bottle portion having a threaded outer neck with an opening and a screw ring that releasably engages therewith to releasably secure a nipple to the opening;
a plurality of one-way valves that permit the passage of formula in one direction from the bottle portion to the nipple;
a containment chamber for providing a space between said plurality of one-way valves to form an assembly;
said assembly being positioned between the opening in the bottle portion and the nipple and wherein said assembly is releasably secured between the opening and the nipple when said releasable screw ring is secured thereover, said assembly preventing any formula that passed through a nipple opening and into contact with the infant and then is returned through the nipple opening from returning to the bottle portion.

15. The infant's bottle of claim 14 wherein said plurality of one-way valves comprises a first one-way valve positioned at a first end of said containment chamber and a second one-way valve positioned at a second end of said containment chamber.

16. The infant's bottle of claim 15 wherein said first end of said containment chamber comprises a valve plate having at least one aperture that is opened or closed by said first one-way valve, said valve plate being in contact with the nipple.

17. The infant's bottle of claim 16 wherein said second end of said containment chamber comprises at least one aperture that is opened or closed by said second one-way valve, said second end being positioned within the opening of the bottle portion.

18. The infant's bottle of claim 14 wherein each one of said plurality of one-way valves comprises an umbrella valve.

19. The infant's bottle of claim 18 wherein each of said umbrella valves comprises a shank having two stops, each of said stops located at a different position along the length of said shank.

20. The infant's bottle of claim 17 further comprising a first gasket positioned between said valve plate and said containment chamber and a second gasket positioned between the opening and said second end of said containment chamber.
